(19) United States
(12) Patent Application Publication
(10) Pub. No.: US 2026/0201975 A1
(43) Pub. Date: Jul. 16, 2026

(54) GAS INLET VALVE HAVING A BELLOWS DRIVE

(71) Applicant: VAT HOLDING AG, Haag (CH)

(72) Inventors: Florian EHRNE, Frümsen (CH); Hanspeter FREHNER, Sevelen (CH)

(21) Appl. No.: 19/139,229

(22) PCT Filed: Dec. 14, 2023
(86) PCT No.: PCT/EP2023/085750

§ 371 Date: Jun. 13, 2025

(30) Foreign Application Priority Data
Dec. 15, 2022 (DE) 10 2022 004 718.7

(51) Int. Cl. F16K 31/126

(52) U.S. Cl. CPC F16K 31/126

(57) ABSTRACT

A gas inlet valve for a vacuum process chamber includes: a gas flow unit having an inner volume, and a sealing surface in the inner volume; an adjustment unit projecting into the inner volume and having a valve disk; a drive unit coupled to the adjustment unit outside the gas flow unit; and a flexible sealing element connected to the gas flow unit and the adjustment unit that atmospherically separates the drive unit from the inner volume. The drive unit has an expansion element, having an expansion that is variable with a variation of the expansion volume, and has a compressed air channel connected to the expansion volume for pressurizing and expanding the expansion volume. The gas inlet valve comprises a coupling unit connected to the drive unit and to the adjustment unit that moves upon variation of the expansion volume and causes a movement of the adjustment unit.

### FIELD OF INVENTION

The present invention relates to a gas inlet valve for admitting a fluid into a vacuum process chamber.

### BACKGROUND OF THE INVENTION

Such vacuum process chambers are used for integrated circuit (IC), semiconductor, flat panel or substrate manufacturing, wherein the vacuum chambers are flooded with a process gas after evacuation for at least part of the process steps. The manufacturing process must take place in a protected atmosphere and, if possible, without the presence of contaminating particles. Evacuation takes place using a vacuum valve, which connects the vacuum process chamber to a vacuum pump and differs from a gas inlet valve in its design and technical requirements.

Furthermore, such vacuum chambers have at least one or two vacuum chamber openings through which the elements to be processed can be guided into and/or out of the vacuum chamber. For example, in a production system for semiconductor wafers or liquid crystal substrates, the highly sensitive semiconductor or liquid crystal elements pass sequentially through several vacuum process chambers in which the elements are processed by means of a processing device in each case.

For example, the element can be placed on extended support pins of a lifting system by means of a robot and deposited on a support, e.g. a potential plate (chuck), by lowering the support pins. After that, the robot arm, which typically carries the element, is moved out of the chamber. The pins can be lowered after the element has been deposited and are then separate from the element, i.e. there is no contact between the pins and the element. After removing the robot arm and closing the chamber, the chamber is usually evacuated and then filled with a process gas, whereupon processing of the element can start.

A gas inlet valve is provided for filling the process chamber with one or more specific process gases or precursors. This allows various substrate processing operations to be provided, such as the targeted deposition of a material layer on a wafer or etching on the wafer surface. In particular, a specific fluid quantity of a process fluid is delivered into the process chamber for this purpose and a reaction of the process fluid with the wafer is started or accelerated, for example, by means of a plasma.

Gas inlet valves are designed in particular for defined control or regulation of the gas flow and are located, for example, within a pipe system between a vacuum process chamber (or a transfer chamber) and a gas source, the atmosphere or another vacuum process chamber. The opening cross-section of such gas inlet valves is usually smaller than that of a vacuum valve.

Depending on the application, gas inlet valves can be used not only to fully open and close an opening, but also to control or regulate a flow by continuously adjusting the opening cross-section between an open position and a gas-tight closed position.

When admitting the process gas into the vacuum chamber, low fluidic effects within the chamber as well as fast and precise filling of the chamber are of great importance. For example, a defined quantity or volume of a defined process gas is to be admitted into the chamber with one opening cycle of the gas inlet valve. For this purpose, on the one hand, a rapid actuation of the valve as well as a precise adjustment of the valve opening cross-section provided in the process is desirable,

Some processing steps typically take place at elevated process temperatures, in particular at more than 100° C. or at more than 150° C. Here, appropriate temperature control of the components in contact with the process gas is desirable in order to avoid inhomogeneous fluid flow or fluid distribution or undesirable deposition processes in and on the components.

In typical gas inlet valves, such an increased temperature can lead to a corresponding temperature increase of the entire valve and thus to problems in the drive mechanics and/or electronics, especially in the area of the drive. In addition, the temperature control of the entire valve can result in a corresponding heat loss due to waste heat.

### OBJECT OF THE INVENTION

Therefore, it is an object of the invention to provide an improved gas inlet valve for a vacuum process to avoid the above disadvantages.

In particular, the object is to provide fast and at the same time continuously precise flooding of a vacuum process chamber with a process gas using the gas inlet valve over a wide temperature range.

### SUMMARY OF THE INVENTION

The present invention relates to a gas inlet valve having a drive unit comprising an expansion element, in particular a bellows. By means of an expansion of the expansion element, a force for opening the valve can be generated. The expansion can be effected in particular by introducing compressed air into the expansion element. The opening force and thus also the extent of the open position of the valve disk can be controlled by adjusting the internal pressure in the expansion element.

The gas inlet valve also has a restoring element, in particular a spring, which presses the valve disk of the valve onto the valve seat and thus interrupts a flow path for a fluid through the valve. By means of the drive, the opening force can be effected, which acts against the restoring force caused by the restoring element. The valve can thus be opened.

In the context of the present invention, fluid is understood to be at least a gas, a gas mixture, a liquid, a precursor-containing gas or a gas-liquid mixture, In particular, the fluid may be a process gas or precursor gas.

The valve disk and/or the valve seat (sealing surface) can have a sealing ring which is pressed or compressed between the valve disk and the valve seat in the closed position. The compression is caused by the pretension of the restoring element and ensures that the gas inlet can be separated from the gas outlet in a gas-tight manner.

By means of controlling the duration of pressurization of the expansion element, it is further possible to adjust an amount of fluid flowing through the valve, e.g. into a vacuum chamber, for a valve opening cycle.

The present invention thus relates to a gas inlet valve for the controlled inlet or flow of a fluid into a vacuum process chamber, wherein the gas inlet valve comprises a gas flow unit having a gas inlet, a gas outlet, and an inner volume, The inner volume connects the gas inlet and the gas outlet. The gas flow unit also has a sealing surface in the inner volume.

The gas inlet valve also has an adjustment unit with a valve disk, wherein the adjustment unit projects into the inner volume and the valve disk is arranged inside the inner volume. The adjustment unit is movably mounted along an adjustment axis in the closing direction and in the opening direction.

The gas inlet valve also has a drive unit which is coupled to the adjustment unit outside the gas flow unit and provides an adjustment of the adjustment unit along the adjustment axis. The valve disk can be brought by means of the drive unit in the opening direction into an open position, in which the valve disk is spaced from the sealing surface and a fluid flow is provided.

Furthermore, a flexible sealing element is provided, which is connected to the gas flow unit and to the adjustment unit and atmospherically separates the drive unit from the inner volume, in particular seals it. The sealing element is designed in particular as a metallic diaphragm.

According to the invention, the drive unit has an expansion element with a variable expansion volume, wherein a variation of a spatial expansion of the expansion element is accompanied by a variation of the expansion volume. The drive unit further comprises a compressed air channel connected to the expansion volume for pressurizing and expanding the expansion volume.

The gas inlet valve further comprises a coupling unit which is connected to the drive unit and to the adjustment unit, and is arranged such that the coupling unit is moved upon variation of the expansion volume and causes movement of the adjustment unit.

The invention thus relates to a gas inlet valve with a drive which provides an alternative drive concept instead of known drive principles for such valves, such as a pneumatic drive or a mechatronic drive with electric motor. The alternative drive with expansion element offers the advantages of robust operation without, in particular, heat-sensitive (electronic) components, while providing fast and precise actuation of the valve opening.

In addition, the valve is advantageously designed in particular for use at elevated temperatures. For this purpose, the expansion element is designed in particular in such a way that, for its aeration and deaeration, respective fluid channels can be provided alone, which are connected to the expansion element and in each case alone to an external unit for providing and/or receiving the fluid. The expansion element itself can form a sealed volume within the drive unit without the need for any further sealing (as required, for example, in the case of pneumatics).

The sealing of the gas flow unit is provided by the flexible, and in particular temperature-resistant, sealing element from the drive.

This means that all components relevant to movement and providing the seal can be arranged and designed in such a way that their functionality is maintained completely and without disadvantages, regardless of the temperature control of the valve.

According to one embodiment, the spatial expansion of the expansion element can be increased by pressurizing the expansion volume and the valve disk can be moved in the opening direction by means of the adjustment unit.

In one embodiment, the gas inlet valve can have one (or more) restoring element(s), in particular spring or elastic element, which is arranged in such a way that the restoring element provides a restoring force acting in the closing direction on the adjustment unit. The restoring element can thus interact with the adjustment unit in such a way that a pretensioning force is provided which presses the valve disk in the closing direction, In particular, the restoring element is appropriately pretensioned in the open position of the valve.

Pressurizing the expansion volume or the expansion element can generate an opening force in the opening direction that counteracts the restoring force. In particular, the restoring element can be in active contact or active connection with the adjustment unit.

In one embodiment, the drive unit can have a further compressed air channel connected to the expansion volume for venting the expansion volume, and the valve disk can be brought into a closed position by venting and reducing the expansion volume in the closing direction, In the closed position, the valve disk contacts the sealing surface, preventing gas from passing through.

Alternatively, both filling of the expansion element, i.e. pressurization, and venting, i.e. relief of excess pressure in the expansion element, can be performed via a single fluid channel.

In one embodiment, the gas inlet valve may include at least one additional expansion element having a variable expansion volume.

In particular, the gas inlet valve may include at least one further compressed air channel for pressurizing and expanding the at least one further expansion volume.

In particular, the coupling unit may be connected to the expansion element and/or to the at least one further expansion element.

By arranging at least one further expansion element (or more thereof), the generation of the force acting on the adjustment unit in the opening direction can be further increased or multiplied. In particular, the total force that can be generated in this way can be greater than the force provided by a single expansion element. In addition, a force sufficient to open the valve can be provided correspondingly faster, which means that a process operated with the gas inlet valve can be carried out correspondingly faster.

The coupling of the expansion elements can be provided, for example, by means of a direct coupling of the individual expansion elements to each other and a connection of the coupled expansion elements to the adjustment unit (by means of the coupling unit). Alternatively or additionally, each of the expansion elements provided can be directly connected to the coupling unit and thus motion-coupled to the adjustment unit.

In one embodiment, the drive unit may comprise a drive plate cooperating with the expansion element, which drive plate is movably mounted along the adjustment axis, is designed to be connected to the coupling unit and, in particular, is connected to the coupling unit.

In particular, the drive unit may have a plurality of drive plates, in particular corresponding to the number of expansion elements present, wherein each of the drive plates cooperates with at least one expansion element and is movable due to a spatial expansion or contraction of the cooperating expansion element, The plurality of drive plates may each be connected to the coupling unit. Thus, a force transmission of the expansion elements to the adjustment unit can be provided and converted into a movement of the valve plate

In one embodiment, the drive unit can have a retaining element that is arranged in a fixed position in the valve. In particular, the retaining element is arranged fixed relative to the valve seat. In particular, the retaining element provides a retaining surface for the expansion element opposite the drive plate, thereby ensuring that the expansion element can only be expanded in the direction of the drive plate. The retaining element thus serves in particular to support the expansion element.

According to one embodiment, the adjustment axis may extend centrally through the valve housing and the adjustment unit may be movably arranged centrally in the valve housing, The coupling unit can have at least one connecting element for connecting the drive unit to the adjustment unit, wherein the connecting element is arranged radially spaced apart from the adjustment unit within the valve housing and extends parallel to the adjustment axis.

The gas inlet valve may have a valve housing. The connecting element may extend parallel to a wall of the valve housing.

The connecting element can, for example, take the form of a bar or rod, in particular made of metal, It is understood that a plurality of such connecting elements can be provided. These can each be arranged radially spaced from the adjustment unit within the valve housing and each extend parallel to the adjustment axis.

In one embodiment, the restoring element may be arranged radially between the connecting element and the adjustment unit.

In one embodiment, the restoring element and the connection element may be coupled to the adjustment unit.

The coupling unit can in particular have a coupling element. The coupling element can be connected to the adjustment unit on the one hand and to the connecting element on the other,

The coupling element can be designed and arranged in such a way that the restoring element presses on this coupling element in its pretensioned setting and thus provides the closing force acting in the closing direction on the valve disk.

In one embodiment, the expansion element can be designed as a bellows, in particular as a gaiter or corrugated bellows, In particular, the bellows can be made of a metallic or metal-containing material. Such a bellows can thus provide a closed body (volume) inside the drive unit and can have openings only to corresponding fluid channels (mentioned above) and be connected by means of these to the outside (from the drive unit) for filling and/or venting.

Alternatively, the expansion element can be of balloon-like design, wherein the expansion element is preferably made of an elastic material.

Regardless of the design of the shape or type of the expansion element, the shell of the expansion element is designed to be gas-tight in particular, In this way, the penetration of impurities, which can be caused by a fluid intended for expansion (e.g. compressed air), into the drive unit can be prevented.

In one embodiment, the expansion element may comprise or be formed from a heat-resistant material.

In one embodiment of the gas inlet valve, the sealing surface, the valve disk, and the sealing element may have a circular cross-section, wherein the inner volume is at least partially cylindrical, and wherein the sealing surface is formed by a shoulder in the inner volume.

The cylindrical shape of the inner volume is formed in particular by the gas flow unit as the shell surface and the sealing element as the base surface, wherein gas inlet and gas outlet can gain free access to the inner volume via the shell surface. This means that gas inlet and gas outlet can each pierce the shell surface.

In particular, the disk divides the inner volume in the closed position into a first and a second partial inner volume, with the gas inlet having free access to the first partial volume and the gas outlet having free access to the second partial volume.

In the provided arrangement in conjunction with a vacuum chamber, the gas outlet has in particular free access to the vacuum process chamber and the gas inlet has in particular free access to process gas source.

### BRIEF DESCRIPTION OF THE DRAWINGS

Further advantages of the present invention are apparent from the detailed description and drawings.

FIG. 1 shows an embodiment of a gas inlet valve according to the invention in a sectional view; and

FIG. 2 shows the gas inlet valve of FIG. 1 in a sectional view rotated about a vertical axis relative to FIG. 1.

### DETAILED DESCRIPTION OF THE DRAWINGS

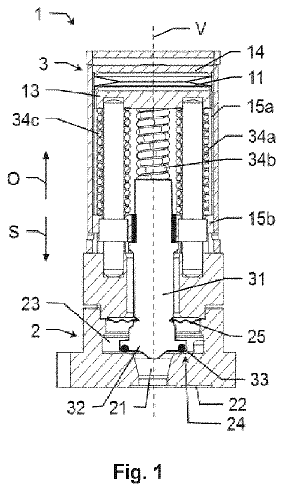

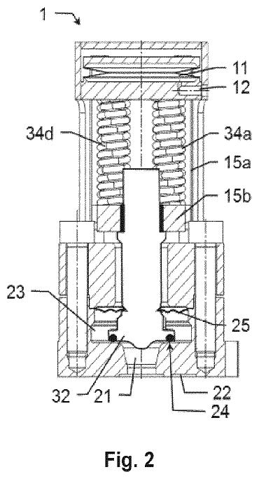

FIGS. 1 and 2 show an exemplary embodiment of a gas inlet valve 1 according to the invention. FIG. 1 shows the valve rotated by 45° about the adjustment axis V relative to the representation in FIG. 2. The gas inlet valve 1 has a gas flow unit 2, which in turn has a gas inlet 21, a gas outlet 22 and an inner volume 23, wherein the inner volume 23 has free access to the gas inlet 21 and to the gas outlet 22 or connects them. The gas flow unit 2 has a sealing surface 24 in the inner volume 23.

The gas inlet valve 1 also has an adjustment unit 31 with a valve disk 32, wherein the adjustment unit 31 projects into the inner volume 23 and is adjustably mounted outside the gas flow unit 2. The valve disk 32 is arranged inside the inner volume 23 and is mounted movably along an adjustment axis V in the closing direction S and in the opening direction O.

The gas inlet valve 1 also has pretensioning or restoring elements 34a-d designed as springs. The springs 34a-d are pretensioned in such a way that they exert a force in the direction of the valve seat and press the adjustment unit 31 or the valve disk 32 onto the sealing surface 24, i.e. in closing direction S.

The pretensioning of the springs presses the disk 32 into a closed position against the sealing surface 24. Here, a sealing ring 33 serves as a gas-tight seal. The sealing ring can be arranged on the plate 32 (as shown here) or on the sealing surface 24 (in other embodiments). This sealing ring consists in particular of an elastomer, thermoplastic material, metal, etc., and may have a shape adapted to the shape of the disk 32 (e.g. an O-ring), or be vulcanized to the disk 32.

The gas inlet valve 1 further comprises a flexible sealing element 25, which in the example shown is designed as a diaphragm, in particular as a metallic diaphragm. The sealing element 25 is connected to the gas flow unit 2 and to the adjustment unit 31 and thus seals the inner volume 23. The flexibly designed diaphragm 25 thus provides a flexible seal of the inner volume 23, in particular with respect to a drive unit 3.

The gas inlet valve 2 has a similar drive unit 3, which is coupled to the adjustment unit 31 outside the gas flow unit 2 and is capable of providing an adjustment of the adjustment unit 31 along the adjustment axis V. The valve disk 32 can be brought by means of the drive unit 3 in the opening direction O into an open position, in which the valve disk 32 is spaced apart from the sealing surface 24 and thus a gas flow is provided between gas inlet 21 and gas outlet 22 through the inner volume 23.

The drive unit 3 has an expansion element 11 with a variable expansion volume. A spatial expansion of the expansion element 11 can be varied by varying the expansion volume (and vice versa). The expansion element 11 can, for example, be designed as a bellows, in particular as a gaiter or corrugated bellows.

The expansion element 11 may be made of a metal-containing material. Alternatively, the expansion element 11 can be made of an elastic material.

In addition, a compressed air channel 12 is provided. The compressed air channel 12 is connected to the expansion element or to the expansion volume and is provided for pressurizing and expanding the expansion volume. The compressed air channel 12 may, on the other hand, preferably be connected to a source of compressed air, for example to a compressor or a pneumatic system (not shown). Thus, compressed air can be supplied to the expansion element 11 through the compressed air channel 12 and an expansion of the volume can be provided.

The inlet valve 1 further comprises a coupling unit connected to the drive unit 3 and to the adjustment unit 31, and arranged such that the coupling unit is moved when the expansion volume is varied, thereby causing the adjustment unit 31 to move. The coupling unit can in particular be directly connected to the expansion element 11.

In the example shown, the coupling unit has a connecting element 15a and a coupling element 15b. The connecting element 15a is designed here as a web, which is arranged radially spaced from the adjustment unit 31 within the valve housing and extends parallel to the adjustment axis V or to a wall of the valve housing. The connecting element 15a is connected at a first end to a drive plate 14 of the drive unit 3. The drive plate 14 is arranged to be movable along the adjustment axis V. Accordingly, a movement of the drive plate 14 causes a movement of the connecting element 15a in a corresponding direction.

The coupling element 15a is further connected at its second end to the coupling element 15b, The coupling element 15b in turn provides a connection with the adjustment unit 31, Thus, a movement of the drive plate 14 is transmitted to the adjustment unit 31 and vice versa.

The drive plate 14 is operatively connected to the expansion element 11 and is designed and arranged in such a way that it is moved in the opening direction O when the expansion element 11 expands. As a result, the valve disk 32 is also moved in the opening direction O and the valve 1 is opened, i.e. the valve disk 32 is in contactless position relative to the sealing surface 24 (valve seat) and a fluid flow is provided.

On the other hand, a movement of the drive plate 14 in closing direction S leads to a compression of the expansion element 11,

Opening of the gas inlet valve 1 can be provided by pressurizing the expansion element 11 by means of the compressed air channel 12. In this case, an expansion of the expansion element 11 is caused due to the pressure in the expansion element 11. Due to the design, the expansion can only take place in the opening direction O with a displacement of the drive plate 14. The side of the expansion element 11 opposite the drive plate 14 is in operative connection with a retaining element 13 fixed in position relative to the valve housing, whereby the force caused by the expansion of the expansion element 11 is able to provide movement of the drive plate 14 alone.

In particular, the pressurization of the expansion element 11 to open the valve is adjusted or selected so that the resulting compressive force on the drive plate 14 exceeds the restoring force provided by the springs 34a-d, thereby permitting movement of the drive plate 14.

In the embodiment shown, the springs 34a-d are braced with the coupling element 15b to provide the restoring force to close the valve 1. As shown, the springs 34a-d may be arranged at their opposite ends on the retaining element 13.

As already mentioned, compressed air is thus forced into the expansion element 11 to open the valve 1, causing the valve disk 32 to be lifted off the sealing surface 24 (cf. FIG. 1). This movement is effected by means of the chain drive plate 14, coupling element 15a, coupling element 15b and adjustment unit 31,

To close the valve 1, the expansion element 11 can be vented. For this purpose, a venting channel (not shown) is preferably provided which can be opened and/or closed in a controlled manner and is connected to the expansion volume. When the venting channel is opened, the compressed air escapes from the expansion element 11, whereby the restoring force becomes greater than the pressure force and the valve disk 32 is moved in the closing direction S as a result.

Alternatively or in addition to a separate venting channel, venting can also be performed through the compressed air channel 12.

The drive of the valve 1 according to the invention is thus advantageously designed in such a way that the drive mechanism is essentially formed by the expansion element and a mechatronic drive can be completely dispensed with. As a result, the operation of the drive is robust against temperature influences and provides reliable operation of the gas inlet valve, advantageously when the valve is used with fluids that are (highly) tempered, for example, to provide improved reactivity. An appropriate temperature control of the valve including the drive can thus be provided without adverse influences on the drive, thus avoiding inhomogeneous fluid flow or fluid distribution or undesirable deposition processes in and on the valve components.

In an embodiment not shown, the drive unit of the gas inlet valve can have at least one further expansion element with a variable expansion volume. This further expansion element can be connected to the compressed air channel and/or to at least one further compressed air channel for pressurization and expansion of the further expansion volume.

The at least one further expansion element can be arranged parallel to the first expansion element and be in direct operative connection with the drive plate.

Alternatively or additionally, the at least one further expansion element can be arranged in series with the first expansion element. In this case, the drive unit can have one or more further drive plates, with the further expansion element contacting the further drive plate and a force generated by pressurization being transmitted to the further drive plate.

The at least one further drive plate may further be connected to the connecting element and provide direct force transmission to the connecting element and thus against the restoring force of the springs.

The multiple arrangement of expansion elements in the drive unit thus enables a force required to open the vaive to be provided comparatively more quickly and/or to a sufficient extent.

The invention is explained with reference to exemplary embodiment(s), but many other changes and variations can be made without going beyond the scope of the present invention. Therefore, it is intended that the appended claims cover changes and variations included in the actual scope of the invention.

1. A gas inlet valve for the controlled inlet of a fluid into a vacuum process chamber, wherein the gas inlet valve comprises:
a gas flow unit having a gas inlet, a gas outlet, and an inner volume connecting the gas inlet and the gas outlet, wherein the gas flow unit has a sealing surface in the inner volume,
an adjustment unit projecting into the inner volume and having a valve disk which is arranged inside the inner volume, wherein the adjustment unit is movably mounted along an adjustment axis in the closing direction and in the opening direction,
a drive unit which is coupled to the adjustment unit outside the gas flow unit and provides an adjustment of the adjustment unit along the adjustment axis, wherein the valve disk can be brought by means of the drive unit in the opening direction into an open position in which the valve disk is spaced from the sealing surface and a fluid flow is provided,
a flexible sealing element which is connected to the gas flow unit and to the adjustment unit and atmospherically separates the drive unit from the inner volume,
wherein
the drive unit has an expansion element with a variable expansion volume, wherein a spatial expansion of the expansion element can be varied with a variation of the expansion volume,
the drive unit has a compressed air channel connected to the expansion volume for pressurizing and expanding the expansion volume, and
the gas inlet valve comprises a coupling unit which is connected to the drive unit and to the adjustment unit and arranged such that the coupling unit is moved upon variation of the expansion volume and causes movement of the adjustment unit.

2. The gas inlet valve according to claim 1, wherein the spatial expansion of the expansion element can be increased by pressurizing the expansion volume and the valve disk can be moved in the opening direction by means of the adjustment unit.

3. The gas inlet valve according to claim 1, wherein
the drive unit has a further compressed air channel connected to the expansion volume for venting the expansion volume, and
the valve disk can be brought into a closed position by means of venting and reduction of the expansion volume in the closing direction, in which closed position the valve disk contacts the sealing surface and gas flow is thus prevented.

4. The gas inlet valve according claim 1, wherein
the gas inlet valve comprises at least one further expansion element with a variable expansion volume,

5. The gas inlet valve according to claim 4, wherein the gas inlet valve comprises at least one further compressed air channel for pressurization and expansion of the at least one further expansion volume.

6. The gas inlet valve according to claim 4, wherein the coupling unit is connected to the expansion element and/or to the at least one further expansion element.

7. The gas inlet valve according to claim 1, wherein
the adjustment axis extends centrally through a valve housing of the gas inlet valve and the adjustment unit is movably arranged centrally in the valve housing, and
the coupling unit has at least one connecting element for connecting the drive unit to the adjustment unit, wherein the connecting element is arranged radially spaced from the adjustment unit inside the valve housing and extends parallel to the adjustment axis.

8. The gas inlet valve according to claim 1, wherein
the gas inlet valve has a restoring element comprising a spring, which is arranged in such a way that the restoring element provides a restoring force acting in the closing direction to the adjustment unit.

9. The gas inlet valve according to claim 7, wherein the restoring element is arranged radially between the connecting element and the adjustment unit.

10. The gas inlet valve according to claim 7, wherein the restoring element and the connection element are coupled to the adjustment unit.

11. The gas inlet valve according to claim 1, wherein
the drive unit comprises a drive plate cooperating with the expansion element, which drive plate is movably supported along the adjustment axis and is adapted to be connected to the coupling unit

12. The gas inlet valve according to claim 1, wherein
the expansion element is formed as a bellows, comprising a gaiter or corrugated bellows.

13. The gas inlet valve according to claim 1, wherein
the expansion element comprises or is formed of a heat-resistant material.
